(19) United States
(12) Patent Application Publication
(10) Pub. No.: US 2019/0261459 A1
(43) Pub. Date: Aug. 22, 2019

(54) MICROWAVE, DISPLAY DEVICE AND COOKING SYSTEM INCLUDING THE SAME

(71) Applicant: Samsung Electronics Co., Ltd., Suwon-si (KR)

(72) Inventors: Jae-hoon CHA, Suwon-si (KR); Hyeong-jin JANG, Seoul (KR); Dong-hyun SOHN, Hwaseong-si (KR)

(21) Appl. No.: 16/122,622

(22) Filed: Sep. 5, 2018

(30) Foreign Application Priority Data
Feb. 19, 2018 (KR) 10-2018-0019314

(51) Int. Cl. H05B 1/02; H05B 6/64; H05B 6/66; H04L 12/28

(52) U.S. Cl. CPC H05B 1/0266; H05B 6/6429; H05B 6/6435; H05B 2213/06; H05B 6/645; H05B 6/6461; H04L 12/2829; H05B 6/668

(57) ABSTRACT

A cooking system is disclosed. The cooking system includes a microwave and a display device. The microwave is configured to in response to a received user command, generate a first image by photographing a cooktop located below the microwave through a first camera or generate a second image by photographing an inside of the microwave through a second camera. The microwave is also configured to transmit at least one of the first image and the second image to the display device. The display device is configured to receive the at least one of a first image and the second image from the microwave and display the received at least one image.

### CROSS-REFERENCE TO RELATED APPLICATIONS

This application claims priority from Korean Patent Application No. 10-2018-0019314, filed on Feb. 19, 2018 in the Korean Intellectual Property Office, the disclosure of which is incorporated herein by reference in its entirety.

### BACKGROUND

### 1. Field

Apparatuses and methods consistent with exemplary embodiments of the present disclosure relate to a microwave, a display device, and a cooking system including the microwave and the display device and, more particularly, to a microwave which provides an image photographed by a camera, a display device, and a cooking system including the camera and the display device.

### 2. Description of Related Art

Recently, development of electronic technology has led to development of various electronic devices that meet the needs of consumers. In particular, recently, an over the range, which is a microwave installed on a cooktop in a house, has been developed.

Here, the cooktop may be implemented solely by an electric range or a gas range, which heats a cooking object in a cooking container through at least one heater, or may be implemented as an oven range which includes an oven underneath the cooktop.

The over-the-range is a microwave installed in an upper direction of the cooktop, and refers to a cooking appliance that heats the cooking object contained in the cooking container using the property of the microwave.

In the meantime, a user may feel a high degree of fatigue because the user needs to constantly check, nearby the cooking object, the overheating or overcooking of the cooking object.

### SUMMARY

Exemplary embodiments address at least the above problems and/or disadvantages and other disadvantages not described above. Also, the exemplary embodiments are not required to overcome the disadvantages described above, and may not overcome any of the problems described above.

The present disclosure includes one or more exemplary embodiments that may address and/or solve the above-mentioned needs, and it is an object of the one or more exemplary embodiments of the present disclosure to provide a microwave, a display device, and a cooking system including the same which can identify overheating or overcooking of a cooking object without continuously checking the cooking object in the vicinity of the cooking object. According to an exemplary embodiment, provided is a cooking system including:

According to an exemplary embodiment, a cooking system is disclosed. The cooking system includes a microwave configured to, according to a user command, generate a first image by photographing a cooktop located below the microwave through a first camera or generate a second image by photographing an inside of the microwave through a second camera, and transmit at least one of the first image and the second image to a display device; and a display device configured to receive at least one of a first image and a second image from the microwave and display the received image.

The display device may, in response to receiving of a user input, transmit a control command for controlling at least one of the microwave and the cooktop to the microwave, and wherein the microwave may receive the control command from the display device and control operations of at least one of the microwave and the cooktop according to the received control command.

The first camera may photograph a first cooking container positioned on the cooktop from a first photographing direction, and the second camera may photograph a second cooking container positioned inside the microwave in a second photographing direction, wherein the microwave may modify the first image which photographs the first cooking container in the first photographing direction and the second image which photographs the second cooking container in the second photographing direction to images corresponding to a third photographing direction, and the third photographing direction may correspond to a vertical direction of the cooking container.

The display device may, while a content is being displayed, when a user input to display at least one image out of the first image and the second image is received, receive at least one image out of the first image and the second image from the microwave, overlap the received image with the content, and display the same.

The display device may, when a user input to change at least one of a size and a position of the displayed image is received, change at least one of a size and a position of the displayed image according to the user input.

The microwave may, based on the first image and the second image, identify a degree of bubble generation in a cooking container located inside the microwave or a cooking container positioned on the cooktop, transmit a notification message indicating a degree of the identified bubbles to the display device, wherein the display device may display the notification message received from the microwave.

The microwave may, based on the first image and the second image, identify a degree of smoke generation in a cooking container positioned inside the microwave or in a cooking container positioned on the cooktop, transmit a notification message indicating a degree of the identified generation of smoke, and when a degree of generation of the smoke is greater than or equal to a predetermined threshold value, stop driving of the electronic unit or drive a hood of the microwave, wherein the display device may display a notification message received from the microwave.

The microwave may identify a degree of blur of at least one image out of the first image and the second image, and identify a camera that photographs an image of which the identified degree of blur is greater than or equal to a preset threshold value out of the first camera and the second camera, and operate a fan which is provided in a vicinity of the identified camera.

According to an exemplary embodiment, a microwave includes an electronic unit; a first camera; a communicator; and a processor configured to, according to a user command, control the communicator to generate a first image by photographing a cooktop positioned below the microwave through the first camera and transmit the first image to a display device.

The microwave may further include a second camera, wherein the processor may control the communicator to generate a second image by photographing an inside of the microwave through the second camera and transmit the second image to a display device.

The processor may receive a control command to control at least one of the microwave and the cooktop from the display device and control operations of at least one of the microwave and the cooktop according to the received control command.

The first camera may be disposed at a specific position of the microwave to photograph a cooking container positioned on the cooktop in a diagonal direction, and the second camera is disposed at a specific position of the microwave to photograph a cooking container positioned inside the microwave in a diagonal direction, wherein the processor may modify an image which photographs the cooking container in the diagonal direction by the first camera and the second camera and transmit the modified image to the display device, and the modified image may correspond to an image photographed the cooking container in a vertical direction.

The processor may, based on the first image and the second image, identify a degree of bubble generation in a cooking container located inside the microwave or a cooking container positioned on the cooktop and transmit a notification message indicating a degree of the identified bubbles to the display device.

The processor may, based on the first image and the second image, identifies a degree of smoke generation in a cooking container positioned inside the microwave or in a cooking container positioned on the cooktop, transmit a notification message indicating a degree of the identified generation of smoke, and when a degree of generation of the smoke is greater than or equal to a predetermined threshold value, stop driving of the electronic unit or drives a hood of the microwave.

The processor may identify a degree of blur of at least one image out of the first image and the second image, and identify a camera that photographs an image of which the identified degree of blur is greater than or equal to a preset threshold value out of the first camera and the second camera, and operate a fan which is provided in a vicinity of the identified camera.

According to an exemplary embodiment, a display device includes a display; a communicator; and a processor which receives, through the communicator, at least one of a first image that photographs a cooktop located below the microwave and a second image that photographs inside the microwave and displays the received image on the display.

The processor may transmit a control command to control at least one of the microwave and the cooktop to the microwave, in response to receiving of a user input.

The processor may, while a content is being displayed, when a user input to display at least one image out of the first image and the second image is received, receive at least one image out of the first image and the second image from the microwave, overlap the received image with the content, and display the same.

The processor may, when a user input to change at least one of a size and a position of the displayed image is received, change at least one of a size and a position of the displayed image according to the user input.

A controlling method includes generating a first image by photographing a cooktop located below the microwave through a first camera according to a user command and transmitting the first image to a display device.

The controlling method of the microwave may further include generating a second image by photographing an inside of the microwave through the second camera according to a user command and the transmitting may transmit the first and second images to the display device.

A controlling method of a display device according to an exemplary embodiment may include receiving at least one of a first image which is generated by photographing a cooktop positioned below the microwave and a second image which is generated by photographing an inside of the microwave and displaying the received image.

According to various embodiments of the present invention as described above, the user can continuously check the cooking object even when the user leaves the kitchen, thereby reducing fatigue from the cooking process. Further, since the microwave and cooktop device can be controlled remotely a space other than the kitchen, user convenience can be increased.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and/or other aspects will be more apparent by describing certain exemplary embodiments, with reference to the accompanying drawings, in which:

FIG. 1 illustrates a cooking system according to embodiments of the present disclosure;

FIG. 2 illustrates a block diagram of a microwave according to embodiments of the present disclosure;

FIGS. 3A to 3B illustrate a camera provided in the microwave according to embodiments of the present disclosure;

FIG. 4 illustrates an image displayed on a display device according to embodiments of the present disclosure;

FIG. 5 illustrates an exemplary embodiment of identifying bubbles generated from the cooking container by the microwave according to embodiments of the present disclosure;

FIG. 6 illustrates an exemplary embodiment of identifying smoke generated from the cooking container by the microwave according to embodiments of the present disclosure;

FIG. 7 illustrates an exemplary embodiment of preventing steam on a camera by the microwave according to embodiments of the present disclosure;

FIG. 8 illustrates an exemplary embodiment of removing a foreign substance by the microwave according to embodiments of the present disclosure;

FIG. 9 illustrates a block diagram of a display device according to embodiments of the present disclosure;

FIGS. 10A to 10E illustrate an exemplary embodiment of displaying an image to photograph an inside of the microwave by the display device and/or an image to photograph a cooktop according to embodiments of the present disclosure;

FIG. 11 illustrates an exemplary embodiment of displaying an image photographed through a camera along with a content by the display device according to embodiments of the present disclosure;

FIGS. 12A to 12C illustrate exemplary embodiments of editing an image photographed by a camera which is displayed on the display device according to embodiments of the present disclosure;

FIGS. 13A to 13E illustrate exemplary embodiments of implementing a display device as a user terminal device according to embodiments of the present disclosure;

FIGS. 14A and 14B illustrate a way that a microwave performs communication according to embodiments of the present disclosure;

FIG. 15 illustrates a detailed block diagram of a microwave according to embodiments of the present disclosure;

FIGS. 16A and 16B illustrate a structure of a microwave according to embodiments of the present disclosure;

FIG. 17 illustrates a flowchart to describe operations of a microwave according to embodiments of the present disclosure; and

FIG. 18 illustrates a flowchart to describe operations of a display device according to embodiments of the present disclosure.

### DETAILED DESCRIPTION

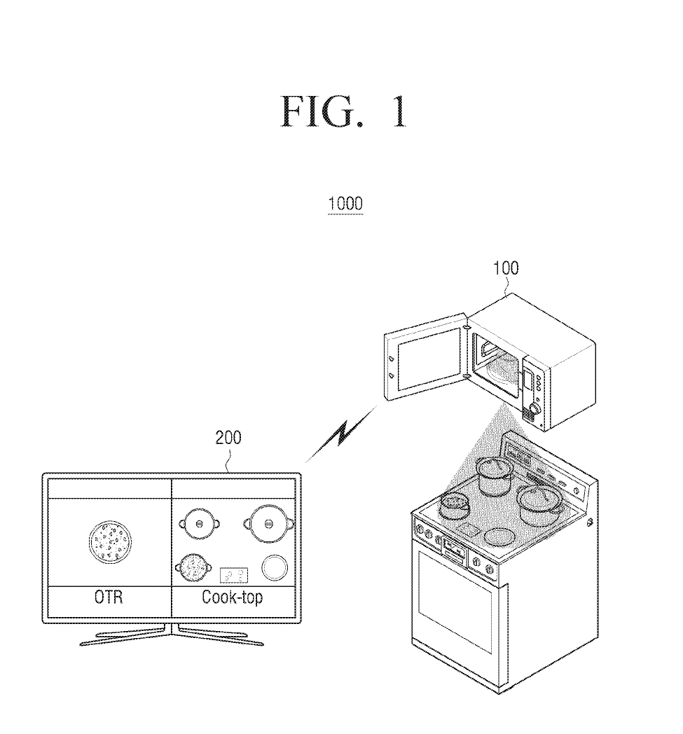

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments may be practiced without those specifically defined matters. Also, well-known functions or constructions are not described in detail since they would obscure the description with unnecessary detail.

Further, although the embodiments of the disclosure are described in detail below with reference to the accompanying drawings and the contents described in the accompanying drawings, the present disclosure is not limited or restricted by the embodiments.

Hereinbelow, the present invention is described in a greater detail with reference to the attached drawings.

FIG. 1 illustrates a cooking system according to embodiments of the present disclosure.

Referring to FIG. 1, a cooking system according to an exemplary embodiment may include a microwave 100 and a display device 200.

As illustrated in FIG. 1, the microwave 100 may be implemented as an over-the-range (OTR), which is a microwave installed on a cooktop, and the display device 200 may be implemented as a smart TV. However, this is only exemplary, and the display device 200 can be implemented as various electronic devices having a display such as a smart phone, a tablet, a PC, a notebook, and the like.

The microwave 100 and the display device 200 may perform communication to transceive various data.

Specifically, the microwave 100 may communicate with the display device 200 to transmit at least one of the first and second images to the display device 200. Here, the first image may be an image of a cooktop located below the microwave 100, and the second image may be an image of the inside of the microwave 100.

The microwave 100 may include at least one of a first camera and a second camera. Here, the first camera may be a camera for photographing the cooktop located below the microwave 100, and the second camera may be a camera for photographing the inside of the microwave 100.

The display device 200 can display an image received from the microwave 100. Here, the received image may be a first image and/or a second image.

Accordingly, the user can confirm whether the cooking object is overheated or overcooked through the display device 200 without continuously checking the cooking object in the vicinity of the cooking object.

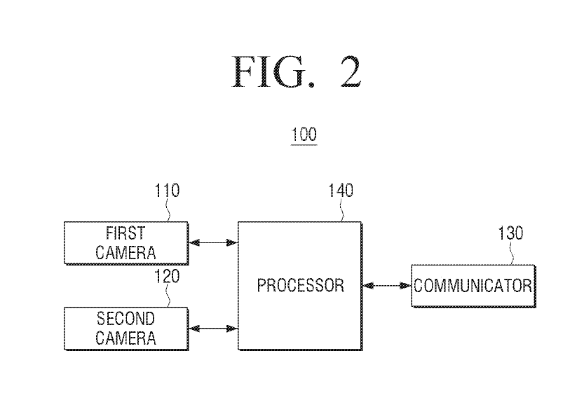

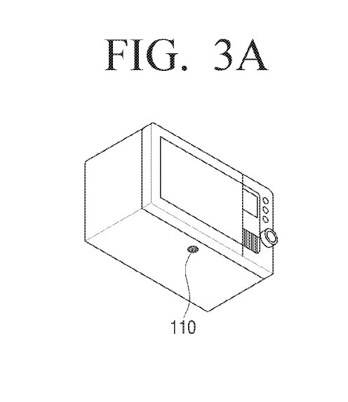

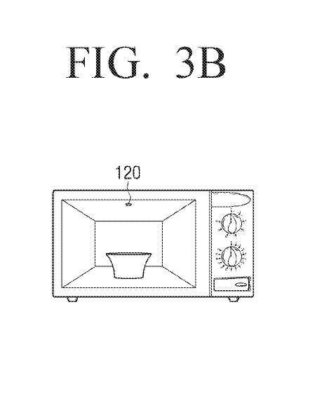

FIG. 2 illustrates a block diagram of a microwave according to embodiments of the present disclosure. For convenient description, FIGS. 3A to 3B will be referred to.

Referring to FIG. 2, the microwave 100 according to an embodiment of the present disclosure includes a first camera 110, a communicator 130, and a processor 140, and may further include a second camera 120.

The first camera 110 can take a picture of the cooktop located below the microwave 100. To this end, the first camera 110 may be provided at a position where the cooktop located below the microwave 100 can be photographed.

For example, referring to FIG. 3A, the first camera 110 may be provided in one area of the lower surface of the microwave 100. In FIG. 3A, an area where the first camera 110 is located is merely exemplary, and the first camera 110 may be located at various positions such as a central area of the lower surface of the microwave 100 for photographing a cooktop positioned at a lower surface of the microwave 100.

The second camera 120 can photograph the inside of the microwave 100. To this end, the second camera 120 may be provided at a position where the inside of the microwave 100 can be photographed.

For example, as shown ire FIG. 3B, the second camera 120 may be provided in one area of the ceilings inside the microwave 100. In FIG. 3B, the area where the second camera 120 is positioned is merely an example, and the second camera can be provided at various positions such as a central area of the ceilings inside the microwave 100 for photographing the inside of the microwave 100.

The communicator 130 may communicate with various types of external devices according to various communication types.

The communicator 130 may communicate with the display device 200 and may transmit at least one of the first and second images to the display device 200. Here, the first image is an image of a cooktop located below the microwave 100 through the first camera 110, and the second image is an image of the inside of the microwave 100 through the second camera 120.

The communicator 130 may communicate with the display device 200 to receive a control command from the display device 200 to control at least one of the microwave 100 and the cooktop. Here, the control command may be a command to control the power on/off of the microwave 100, the cooking time or the power on/off of the cooktop, the heat temperature control of the heater of the cooktop and the like.

In addition, the communicator 130 may communicate with the cooktop so as to transmit a control command to the cooktop. Here, the control command may be a control command received from the display device 200 described above. For example, the control command may be a command to control power on/off of the cooktop, temperature control of the heater of the cooktop, and the like.

The communicator 130 may include wireless communication chips such as Wi-Fi chip, a Bluetooth chip, and the like.

In addition, the microwave 100 may further include an electronic unit [symbol] (not shown). Various electric components such as a magnetron and a high-voltage transformer for oscillating a microwave to cook a cooking object inside the microwave 100 may be installed in the electronic unit.

The processor 140 controls the overall operation of the microwave 100. To this end, the processor 140 may include one or more of a central processing unit (CPU), an application processor (AP), or a communication processor (CP).

The processor 140 may control the communicator 130 to transmit at least one of the first and second images to the display device 200. Here, the first image is an image of a cooktop located below the microwave 100 photographed through the first camera 110, and the second image is an image of the inside of the microwave 100 photographed through the second camera 120.

Specifically, when a signal requesting the first image is received from the display device 200, the processor 140 may generate a first image through the first camera, and transmit the generated first image to the display device 200. When a signal requesting the second image is received from the display device 200, the processor 140 may generate a second image through the second camera and transmit the generated second image to the display device 200.

When a signal requesting the first image and the second image is received from the display device 200, the processor 140 may generate the first image through the first camera and the second image from the second camera, and transmit the generated first image and the second image to the display device 200.

The processor 140 may receive a control command from the display device 200 to control at least one of the microwave 100 and the cooktop. Here, the control command may be a command to control the power on/off of the microwave 100, the cooking time or the power on/off of the cooktop, the heat temperature control of the heater of the cooktop, and the like.

When the control command received from the display device 200 is a control command for controlling the microwave 100, the processor 140 may control the function of the microwave 100 according to the received control command. For example, when the control command is a command to turn off the power of the microwave 100, the processor 140 may turn off the power of the microwave 100 based on the control command.

In addition, the processor 140 may transmit the received control command to the cooktop if the control command received from the display device 200 is a control command for controlling the cooktop. For example, if the control command is a command to turn off the cooktop, the processor 140 may transmit the received control command to the cooktop. Thereafter, the cooktop can control the function of the cooktop based on the control command received from the microwave 100. In the present embodiment, the cooktop can power off the cooktop based on the received control command.

As described above, by displaying the image of the inside of the microwave 100 photographed by the microwave 100 through the display device 200 or the image of the cooktop photographed by the microwave 100, the user can continuously check the cooking object in the vicinity of the cooking object without a need to keep checking the cooking object.

In addition, the user can control at least one of the microwave 100 and the cooktop remotely, without having to move near the cooking object and thus, user convenience can be increased.

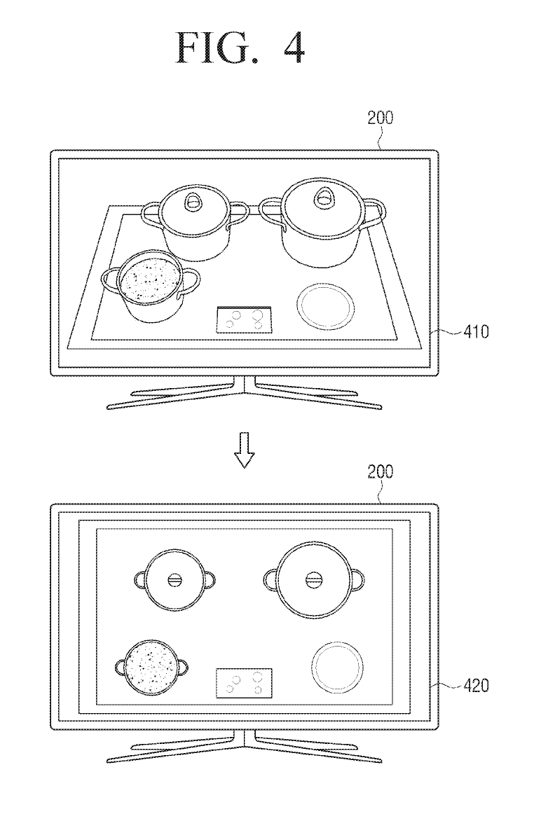

FIG. 4 illustrates an image displayed on a display device according to embodiments of the present disclosure.

The first camera 110 of the microwave 100 according to an embodiment of the present disclosure may be provided in one area of the lower surface of the microwave 100 as shown in FIG. 3A. That is, the first camera 110 may be disposed at a specific position of the microwave 100 to photograph the cooking container placed on the cooktop in a diagonal direction.

In addition, the second camera 120 of the microwave 100 according to an embodiment of the present disclosure may be provided in one of the ceilings inside the microwave 100, as shown in FIG. 3B. That is, the second camera 120 may be disposed at a specific position of the microwave 100 to photograph the cooking container located inside the microwave 100 in a diagonal direction.

Accordingly, a lens of the camera can be protected from steam and so on which is generated from cooking.

Meanwhile, the microwave 100 according to an embodiment of the present disclosure may modify the image 410 photographed in the diagonal direction and transmit the modified image 410 to the display device 200.

Here, the modified image may correspond to the image 420 in which the cooking container is photographed in the vertical direction as shown in FIG. 4.

To this end, the processor 140 may utilize an internal image of the pre-stored microwave 100 and an image of the cooktop or may use an outline detection algorithm.

Specifically, the processor 140 may compare the pre-stored image of the cooktop with the first image photographed through the first camera 110, and identify an image matching the cooktop in the rectangular shape in the first image. The processor 140 may modify the first image to correspond to the image photographed in the vertical direction by modifying the first image so as to correspond to the image photographed in a direction perpendicular to the cooktop of the rectangular shape.

Similarly, the processor 140 may compare the pre-stored internal image of the microwave 100 with a second image photographed through the second camera 120 and identify an image matching the circular disc in the microwave 100 in the second image. The processor 140 may modify the second image to correspond to the image photographed in the vertical direction by modifying the second image to correspond to the image photographed in the direction perpendicular to the round disc.

In addition, the processor 140 may identify the edge of the cooktop on the first image or identify the round disc on the second image through an outline algorithm, and then, as described above, the first and second images can be modified to correspond to the image photographed from a vertical direction to the cooking container.

Accordingly, the user has the effect of confirming the entire cooking object contained in the cooking container through the display device 200.

In the case where the cooking container is placed only on a part of the plurality of heaters of the cooktop, the processor 140 may generate an image excluding the heater on which the cooking container is not mounted.

For this purpose, the processor 140 may compare the pre-stored heater image with the image photographed by the first camera 110 to identify an area matching the pre-stored heater image. Here, the matching area is an area where the cooking container is not positioned, and the non-matching area is an area where the cooking container is positioned.

Thereafter, the processor 140 crops the identified area, thereby generating an image excluding the heater where the cooking container is not positioned.

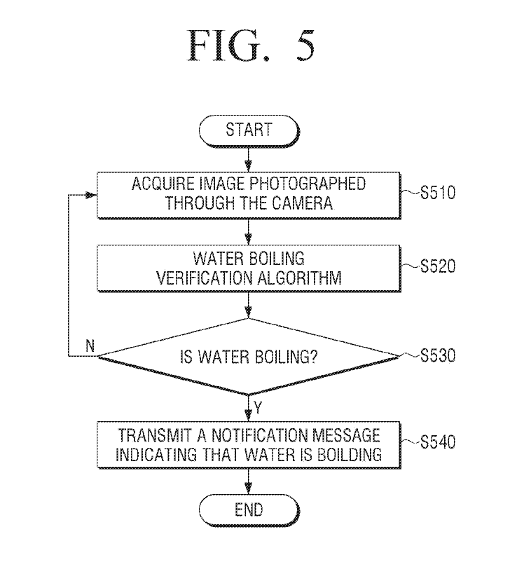

FIG. 5 illustrates an exemplary embodiment of identifying bubbles generated from the cooking container by the microwave according to embodiments of the present disclosure.

The processor 140 may acquire an image photographed through the camera (S510). Here, the image may be a first image which photographs a cooktop positioned at a lower side of the microwave 100 through the first camera 110 and a second image which photographs an inside the microwave 110 through the second camera 120.

The processor 140 may operate the water boiling verification algorithm (S520). Here, the water boiling verification algorithm may be a bubble generation detection algorithm. Specifically, the processor 140 can identify (S530) that the water is boiling when it is identified that the bubbles having a predetermined threshold value or more have been generated in the image through the bubble generation detection algorithm.

If it is confirmed that the water is boiling, the processor 140 may transmit a notification message indicating the degree of occurrence of bubbles, that is, a notification message indicating that water is boiling, to the display device 200 (S540).

Accordingly, the user can recognize the boiling water of the cooking container without continuously checking the cooking object in the vicinity of the cooking container.

It is merely an embodiment to identify that the water is boiling through the water boiling algorithm, and the water boiling can be identified by various methods. For example, when information indicating that the change in the RGB value of the pixel included in the image is equal to or more than A is stored in the microwave 100, the processor 140 may identify that, if the change in the RGB value of the specific pixel is equal to or more than A, water is boiling.

The processor 140 may also use artificial intelligence techniques to identify boiling water. Artificial intelligence technology is a technology that a computer machine that realizes a human level intelligence learns and determines for itself, and a recognition rate improves as it is used. The processor 140 may identify the user through a deep learning using an algorithm that self-categorizes/learns the characteristics of the input data.

Specifically, the processor 140 can learn that bubbles have generated when the degree of generation of water vapor in the image photographed using a camera is a first level, and when the degree of occurrence of water vapor is a second level in which steam is generated more than as in the first level, and if a level of vapor generation is a third level, it can be learned that much bubbles are generated. After repeating such learning, the processor 140 can recognize that water is boiling When the degree of generation of water vapor is in the third level.

On the other hand, the processor 140 may control the microwave 100 to heat the cooking object contained in the cooking container inside the microwave 100, if the water boiling of the cooking container on the cooktop is identified. Specifically, the processor 140 may control the microwave 100 to heat the cooking object contained in the cooking container inside the microwave 100 for a predetermined time when water boiling of the cooking container on the cooktop is identified. Here, the predetermined time can be set variously by the user, such as one minute and three minutes, and so on.

This is because when the boiling water of the cooking container on the cooktop is generated, the cooking object on the cooktop is being completely cooked. At this time, the cooking object in the microwave 100 also begins to be heated, in order to complete cooking of the cooking object inside the microwave 100 at a time point similar to the cooking completion time of the cooking object on the cooktop.

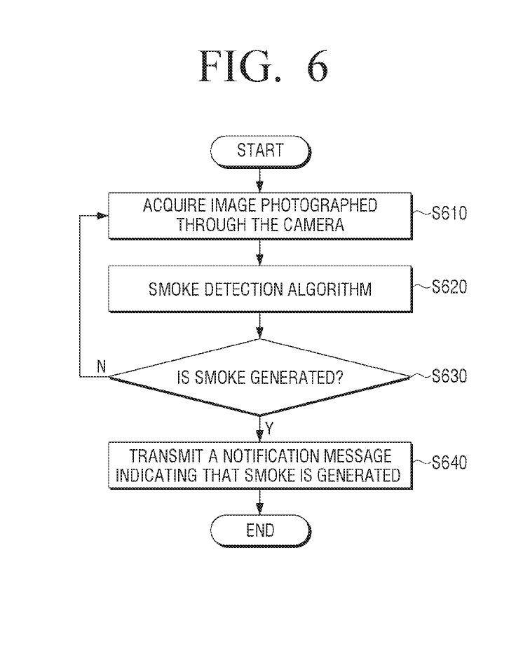

FIG. 6 illustrates an exemplary embodiment of identifying smoke generated from the cooking container by the microwave according to embodiments of the present disclosure.

The processor 140 may acquire an image photographed through the camera (S610). Here, the image may be first image which photographs an inside of the microwave 100 through the first camera and a second image which photographs a cooktop positioned at a lower side of the microwave 100 through the second camera 120.

Then, the processor 140 may operate the smoke detection algorithm (S620). Here, the smoke detection algorithm may be an algorithm for determining whether smoke is generated or not, based on a change in the RGB value of a pixel included in the image. Specifically, the processor 140 can identify that a smoke is generated when a pixel having an identical R, G, or B value exists in the image, and if the pixel having an identical R, G, and B is more than a predetermined number, it can be identified that a large amount of smoke has been generated.

If it is identified that the smoke is generated, the processor 140 may transmit a notification message indicating the degree of occurrence of the identified smoke to the display device 200 (S640).

In addition, the processor 140 may operate the hood of the microwave if the degree of smoke generation is identified as being above a predetermined threshold value. Here, the hood may be provided in connection with the microwave 100.

Also, the processor 140 may terminate the operation of the device corresponding to the detected smoke image if the degree of smoke generation is greater than or equal to a predetermined threshold value and lasts for a preset time period. For example, if it is identified in the first image that smoke is generated continuously, the operation of the heater of the cooktop can be terminated, and if it is identified in the second image that smoke is generated continuously, the operation of the microwave 100 can be terminated.

Accordingly, a user may recognize that smoke is generated from the cooking container, without a necessity to check the cooking object continuously in the vicinity of the cooking container.

Also, the processor 140 may terminate the operation of the device corresponding to the detected smoke image if the degree of smoke generation is greater than or equal to a predetermined threshold value and lasts for a preset time period. For example, if it is identified that the first image is generated by continuing the smoke, the operation of the heater of the cooktop is terminated, and if the second image is identified as being generated continuously, the operation of the microwave 100 is terminated. Accordingly, the user can recognize occurrence of smoke in the cooking container without continuously checking the cooking object near the cooking container. In addition, even if the user does not recognize the occurrence of smoke, it is possible to prevent damage due to smoke generation by automatically operating the hood or terminating the operation of the heater when a large amount of smoke is generated.

It is only one embodiment to identify the generation and degree of smoke in the cooking container through the smoke detection algorithm, and the generation and the degree of generation of smoke can be identified by various methods. For example, smoke may be detected by a smoke detection sensor (not shown). In addition, the smoke can be identified using artificial intelligence technology as described above.

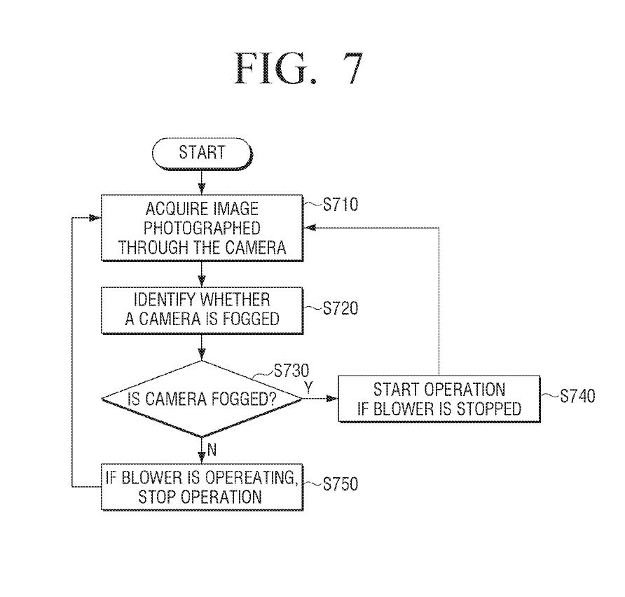

FIG. 7 illustrates an exemplary embodiment of preventing steam on a camera by the microwave according to embodiments of the present disclosure.

The processor 140 may acquire an image photographed through the camera (S710). Here, the image may be a first image which photographs a cooktop positioned in a lower side of the microwave 100 through the first camera 110 or a second image which photographs an inside of the microwave 100 through the second camera 120.

In addition, the processor 140 may identify whether at least one of the first and second cameras is fogged (S720). Specifically, the processor may identify the degree of blur of at least one of the first and second images, and identify the camera that photographs the image whose blur level is equal to or greater than a predetermined threshold value via a fogged camera (S730).

When the camera for photographing the image having the degree of blur equal to or higher than the predetermined threshold value is identified, the processor 140 may drive a blower provided in the vicinity to the identified camera (S740). Here, the blower may be a fan. Depending on the operation of the blower, it is possible to remove the fog from the camera.

If it is identified that a fogged camera does not exist, the processor 140 may stop the operation of the blower (S750).

Accordingly, the microwave 100 according to an exemplary embodiment may provide an image where an object is photographed clearly.

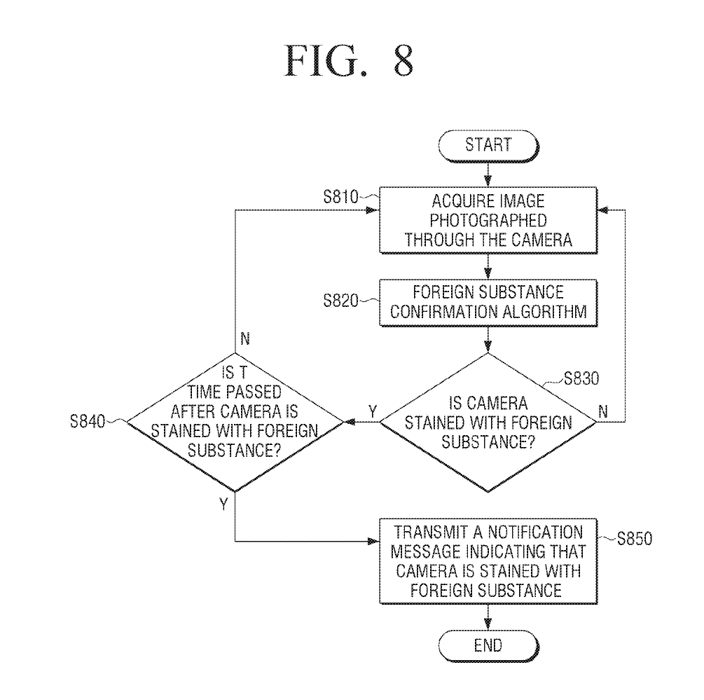

FIG. 8 illustrates an exemplary embodiment of removing a foreign substance by the microwave according to embodiments of the present disclosure.

The processor 140 may obtain an image photographed by a camera (S810). Here, the image can be a first image which photographs a cooktop positioned at a lower side of the microwave 100 through the first camera 110 or a second image which photographs an inside of the microwave 100 through the second camera 120.

Then, the processor 140 may operate the foreign substance confirmation algorithm (S820). Specifically, if the pixel value change of the image currently photographed through the camera and the image photographed immediately before is greater than a preset value, the processor 140 can identify that the camera is stained with the foreign substance (S830). Particularly, the processor 140 can identify that the foreign substance is attached to the camera when the pixel whose pixel value change is equal to or greater than a predetermined value is concentrated in a specific region of the image.

The processor 140 may check whether the identified foreign substance lasts for a preset time or longer (S840). This is to distinguish between the foreign substance and the cooking container, or the foreign substance and the cooking object. If the identified foreign substance persists for a preset time period, the processor 140 may transmit a notification message, to the display device, indicating the presence of the foreign substance (S850).

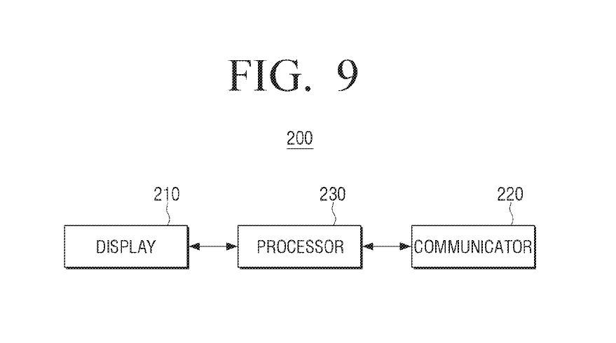

FIG. 9 illustrates a block diagram of a display device according to embodiments of the present disclosure.

Referring to FIG. 9, a display device 200 according to an embodiment of the present disclosure may include a display 210, a communicator 220, and a processor 230.

The display 210 may display various images. Here, an image is a concept that includes still images and moving images.

Specifically, the display 210 may display a broadcast image and a multimedia content image. In addition, the display 210 may display at least one image from among the first image which photographs a cooktop positioned at a lower side of the microwave 100 and the second image which photographs an inside of the microwave 100.

In addition, the display 210 may display at least one of the first image which photographs a cooktop positioned at a lower side of the microwave 100 and the second image which photographs an inside of the microwave 100, along with the broadcast video and multimedia content, etc.

In addition, the display 210 may display a UI for receiving a control command for controlling at least one of the microwave 100 and the cooktop.

The display 210 may be implemented as various types of displays such as a liquid crystal display panel (LCD), a light emitting diode (LED), an organic light emitting diode (OLED), a liquid crystal on silicon (LCoS) and digital light processing (DLP). In addition, inside the display 210, driving circuits which can be implemented such as a-si TFT, a low temperature poly silicon (LTPS) TFT, an organic TFT (OTFT), a backlight unit, and the like that can included.

The communicator 220 can perform communication with various types of external devices according to various types of communication methods.

The communicator 220 may communicate with the microwave 100 to receive at least one of the first and second images from the microwave 100. Here, the first image is an image of a cooktop located below the microwave 100 through the first camera 110, and the second image is an image captured by the microwave 100 through the second camera 120.

The communicator 220 may communicate with the microwave 100 and transmit a control command to control at least one of the first and second images from the microwave 100. Here, the control command can be a command to set power on/off, cooking time, power on/off of a cooktop, or control temperature of the heater of the cooktop.

In addition, the communicator 220 may communicate with the cooktop and directly transmit the control command to the cooktop. Here, the control command may be a command for controlling the power on/off of the cooktop, the temperature control of the heater of the cooktop, and the like.

To this end, the communicator 220 may include a wireless communication chip such as a Wi-Fi chip and a Bluetooth chip.

The processor 230 controls the overall operation of the display device 200. To this end, the processor 230 may include one or more of a central processing unit (CPU), an application processor (AP), or a communication processor (CP).

The processor 230 may receive at least one of the first and second images from the microwave 100 through the communicator 220. Here, the first image may be an image of a cooktop located below the microwave 100, and the second image may be an image of the inside of the microwave 100.

Specifically, the processor 230 may transmit a signal requesting a first image to the microwave 100 based on a user input, and may receive a first image from the microwave 100. The processor 230 may transmit a signal requesting a second image to the microwave 100 based on a user input, and may receive a second image from the microwave 100.

The processor 230 may also transmit the first and second images to the microwave 100 based on user input and receive the first and second images from the microwave 100.

The processor 230 may then send a control command for controlling at least one of the microwave 100 and the cooktop from the microwave 100 based on user input. Here, the control command may be a command for controlling the power on/off of the microwave 100, setting the cooking period or power on/off of the cooktop, and controlling the heat temperature of the heater of the cooktop.

The processor 230 may also send a control command to the cooktop directly to control the cooktop based on user input. Here, the control command may be a command for controlling the power on/off of the cooktop, the heat temperature of the cooktop, and the like.

Thus, by displaying the image of the inside of the microwave 100 taken by the display device 200 or the image of the cooktop, the user can continuously check the cooking object even in the area outside the kitchen.

Also, since the over-the-range or the heater of the cooktop can be controlled near the display device 200 without having to control the over-the-range or the heater of the cooktop near the cooking object, user convenience can be increased.

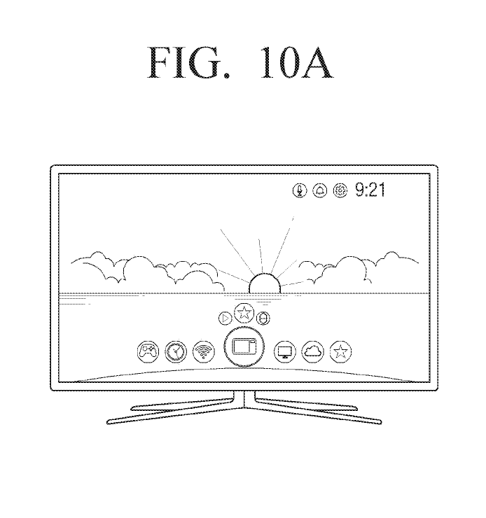

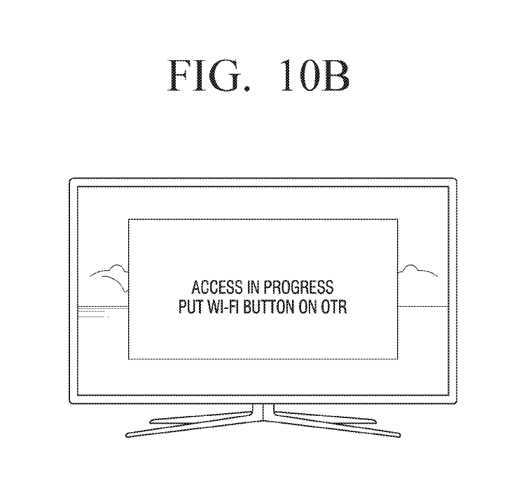

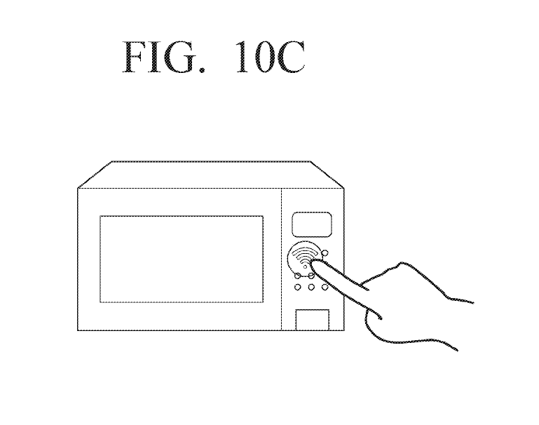

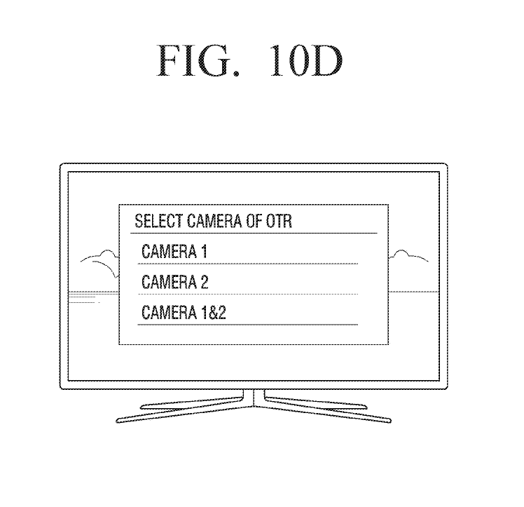

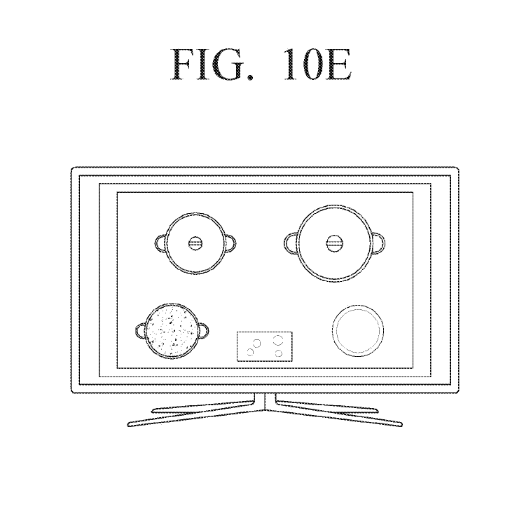

FIGS. 10A to 10E illustrate an exemplary embodiment of displaying an image to photograph an inside of the microwave by the display device and/or an image to photograph a cooktop according to embodiments of the present disclosure.

Hereinafter, it is assumed that the microwave 100 is implemented as an over-the-range (OTR) for convenience of explanation.

As shown in FIG. 10A, the processor 230 may display various application menus. For example, the processor 230 may display various application menus, such as a video application, a photo application, an SNS application, etc., including an OTR camera application.

Thereafter, when the OTR camera application is selected according to the user input, the processor 230 may display a message indicating that a communication connection with the OTR is being performed, as shown in FIG. 10B. Here, the user input may be performed in various ways such as an operation of touching the OTR camera application on the display of the display device 200 or an operation of selecting the OTR camera application via the remote control device. To this end, the display device 200 may further include a remote control receiver.

As illustrated in FIG. 10C, if the user inputs a command to activate the communication part of the OTR through the button provided in the OTR, the processor 230 can perform a communication connection with the OTR. This is for taking into account of security concerns. Specifically, it is intended to prevent a display device in another house from making a communication connection with the OTR in the user's house to operate the camera of the OTR.

In the meantime, activating the communicator of the OTR can be performed only when the display device 200 and the OTR are communicatively connected initially. That is, the processor 230 performs a communication connection with the OTR through such an operation, and can immediately perform a communication connection with the OTR when the OTR camera application is selected according to user input.

In FIG. 10C, it is illustrated that the communicator of the OTR is activated through a button provided in the OTR, but this is only an embodiment. The communicator of the OTR may be activated via the remote control device.

Thereafter, as shown in FIG. 10D, the processor 230 may display a UI requesting to select a camera of the OTR. Here, the UI of camera 1 is a UI for selecting a first camera for photographing the cooktop located below the microwave 100, and the UI of camera 2 is for selecting a second camera for photographing the inside of the microwave 100, and the UIs of camera 1 & 2 may be a UI for selecting both the first and second cameras.

Then, when a camera is selected through the displayed UI, the processor 230 can display the image photographed by the selected camera.

Specifically, when the UI of camera 1, the processor 230 may display the image of the cooktop located below the microwave 100 through the first camera, and when the UI of camera 2 is selected, the image of the inside of the microwave 100 photographed through the second image may be displayed. When the UIs of camera 1 & 2 are selected, both the image of the cooktop positioned below the microwave 100 which is photographed through the first camera and the image of the inside of the microwave 100 photographed by the second camera can be displayed.

For example, when the UI of camera 1 is selected, the processor 230 can display an image of the cooktop located below the microwave 100 as shown in FIG. 10E.

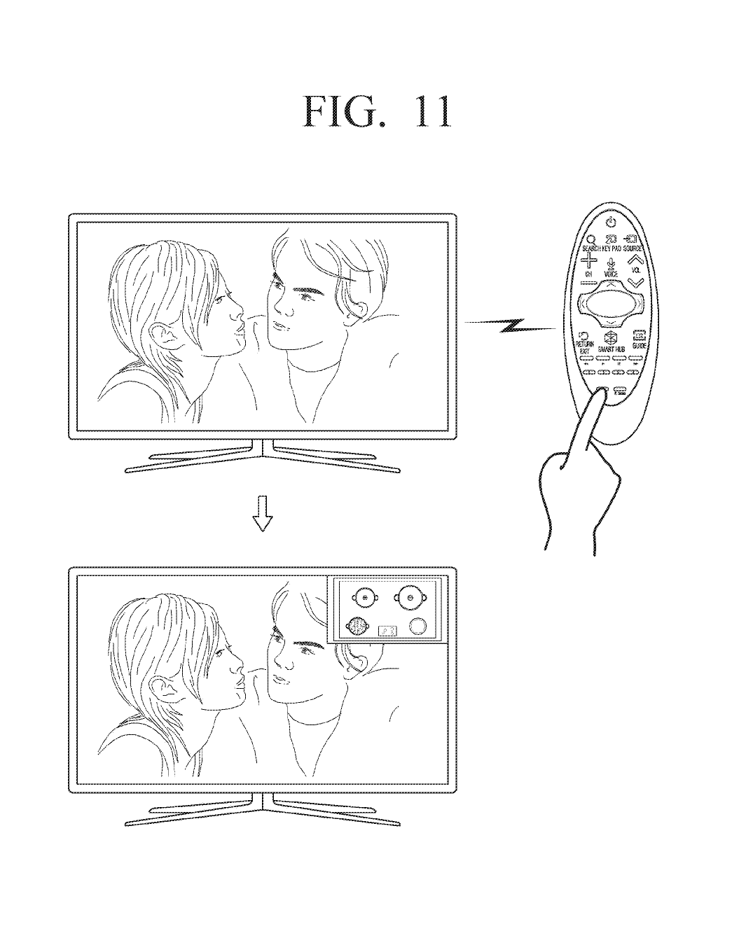

FIG. 11 illustrates an exemplary embodiment of displaying an image photographed through a camera along with a content by the display device according to embodiments of the present disclosure.

The processor 230 may display various contents such as a broadcast image and a multimedia content image on the display 210.

When a user input for displaying at least one of the first and second images is received while the content is being displayed, the processor 230 may receive at least one of the first and second images from the OTR and can overlap and display the received image on the content. Here, the degree of overlapping can be set differently according to user setting.

For example, if the OTR button of the remote control device is selected while the broadcast image is displayed, the processor 230 may display a UI requesting to select at least one of first camera and the second camera.

When the first camera out of the first camera and the second camera is selected, the processor 230 may transmit a signal requesting an image photographed by the first camera to the OTR, and transmit an image photographed by the first camera to the OTR, and receive and display the image photographed by the first camera from the OTR.

Similarly, when the second camera is selected, the processor 230 can transmit a signal requesting an image photographed by the second camera to the OTR, receive and display the image photographed by the second camera from the OTR, and when the first and second cameras are selected, the processor 230 may transmit a signal requesting an image photographed by the first and second cameras to the OTR, and transmit an image photographed by the first and second cameras to the OTR; and can receive and display the image photographed by the first camera and the second camera from the OTR.

In the meantime, receiving the user input by the operation of pressing the OTR button of the above-described remote control device is merely an embodiment, and the user input may be received by the operation of touching the display 210 of the display device 200.

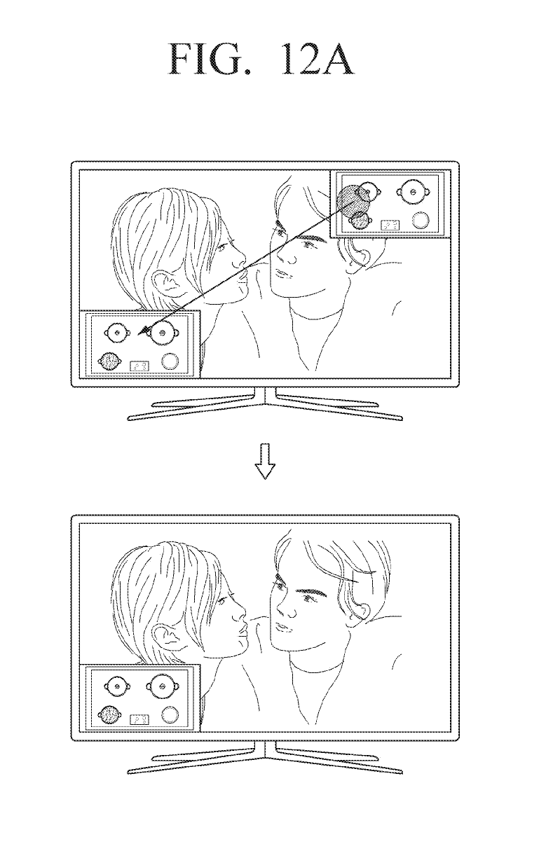

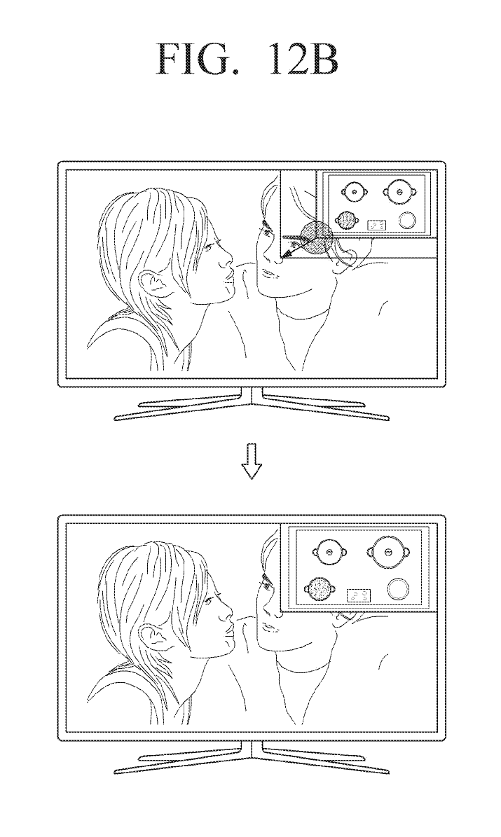

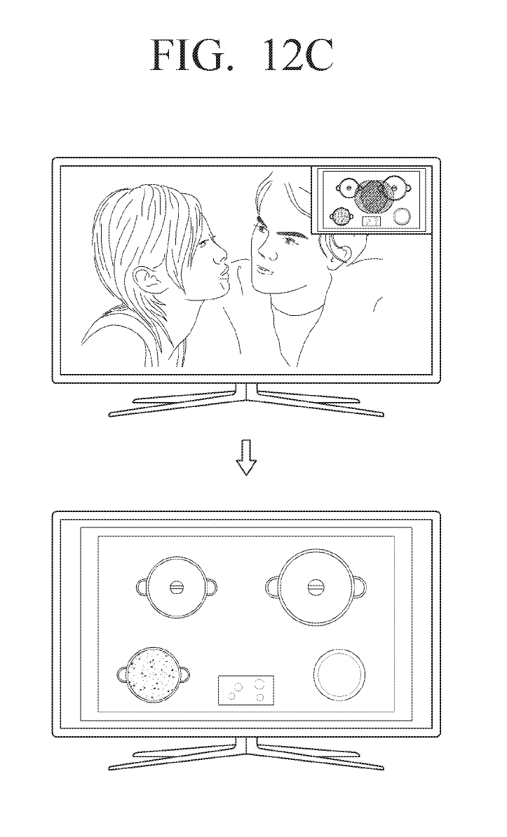

FIGS. 12A to 12C illustrate exemplary embodiments of editing an image photographed by a camera which is displayed on the display device according to embodiments of the present disclosure.

The processor 230 may edit the image photographed by the camera displayed on the display 210 according to the user input.

Specifically, when the user input for changing at least one of the size and the position of the image photographed by the camera displayed on the display 210 is received, the processor 230 may change at least one of a size and a position of the displayed image according to the user input.

For example, referring to FIG. 12A, when an operation of dragging a portion of an image photographed by a camera to another region after touching is input, the processor 230 can move the photographed image according to a drag operation.

Referring to FIG. 12B, if an edge region of an image photographed by a camera is touched and then an operation of dragging the edge region to another region is inputted, the processor 230 may change the size of the photographed image according to the dragging operation.

Referring to FIG. 12C, when an operation of double-touching a border area of an image photographed by a camera is input, the processor 230 may change the size of the photographed image to correspond to the entire screen size of the display 210.

Meanwhile, the touch and drag operation, the double touch operation, and the like can be performed in various ways. For example, a touch-drag operation, a double-touch operation, and the like can be performed through a touch pad provided in the remote control device, and a touch-and-drag operation, a double-touch operation, or the like may be performed through the display 210 of the display device 200.

Also, editing of the image may be performed on each of the first and second images. Specifically, when one of the first and second images is selected and the drag operation is input to the selected image in a state where the first and second images are displayed, the processor 230 may move only the selected image to another position or display the same after magnifying the image.

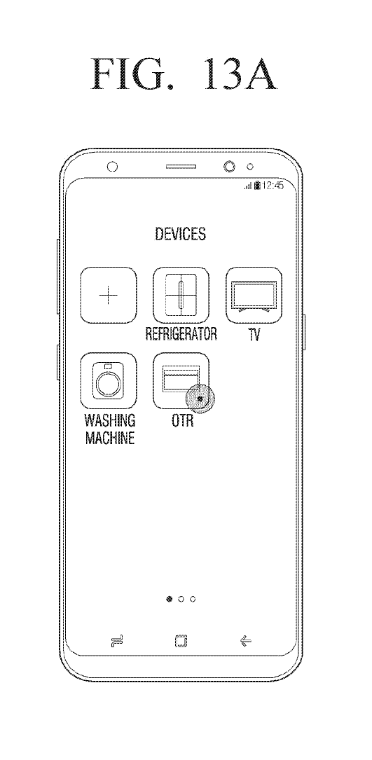

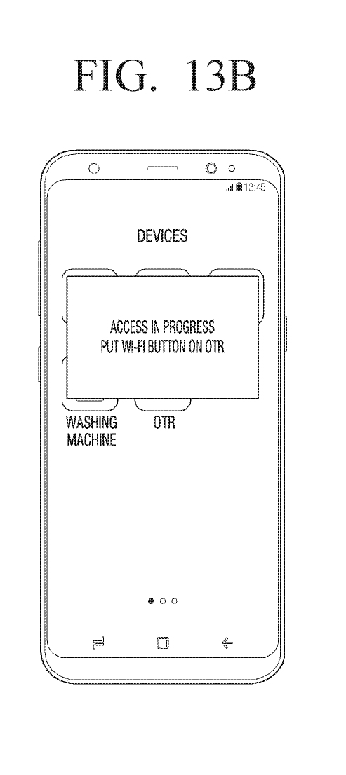

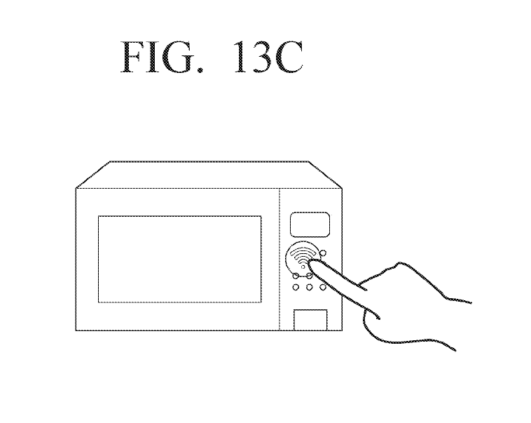

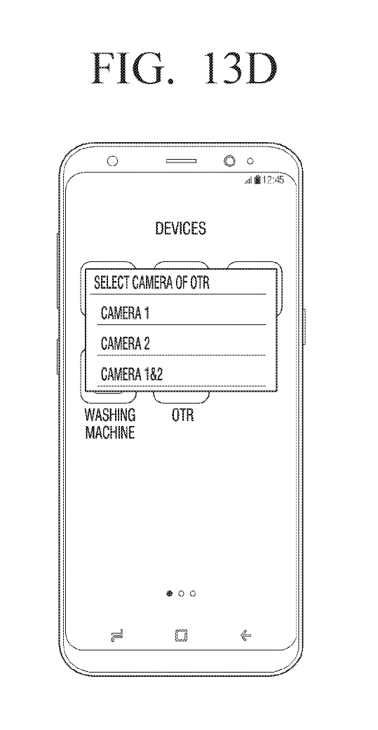

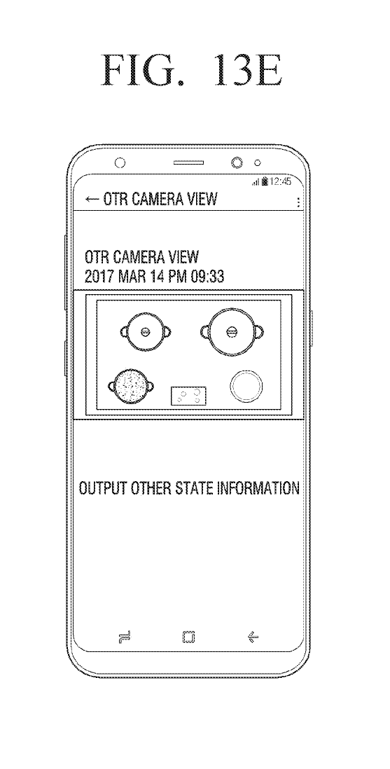

FIGS. 13A to 13E illustrate exemplary embodiments of implementing a display device as a user terminal device according to embodiments of the present disclosure.

As shown in FIG. 13A, the processor 230 may display various application menus. For example, the processor 230 may display various application menus, including an OTR camera application, such as a refrigerator application, a TV application, a washing machine application, and the like.

Thereafter, when the OTR camera application is selected according to user input, the processor 230 may display a message indicating that a communication connection with the OTR is being performed, as shown in FIG. 13B. Here, the user input may be received by an operation in which the user touches the OTR camera application on the display of the display device 200.

At this time, if the user inputs a command to activate the communication part of the OTR through the button provided in the OTR, the processor 230 can perform a communication connection with the OTR as shown in FIG. 13C. This takes into account security concerns. Specifically, it is intended to prevent a user terminal of another user from making a communication connection with the OTR in the user's house and operating the camera of the OTR.

In the meantime, activating the communicator of the OTR can be performed only when the display device 200 and the OTR are communicatively connected initially. That is, the processor 230 may perform a communication connection with the OTR through such an operation, and can immediately perform a communication connection with the OTR when the OTR camera application is selected according to user input.

In FIG. 13C, the communicator of the OTR is activated through the button provided in the OTR, but this is only an embodiment. The communicator of the OTR may be activated via the remote control device.

As shown in FIG. 13D, the processor 230 may display a UI requesting to select a camera of the OTR. Here, the UI of Camera 1 is a UI for selecting a first camera for photographing the cooktop located below the microwave 100, and the UI for camera 2 is for selecting a second camera for photographing the inside of the microwave 100, and the UIs of camera 1 and camera 2 may be UIs for selecting both the first and second cameras.

The processor 230 may, when a camera is selected through the displayed UI, display an image which is photographed by the selected camera.

Specifically, when the UI of camera 1 is selected, the processor 230 displays the photographed image of the cooktop located below the microwave 100 through the first camera. When the UI of camera 2 is selected, the processor 230 may display both the image which photographs the inside of the microwave 100 through the first camera and the image which photographs the cooktop which is located below the microwave 100 through the second camera.

For example, when the UI of camera 1 is selected, the processor 230 may display an image which photographs the cooktop located below the microwave 100 as illustrated in FIG. 13E.

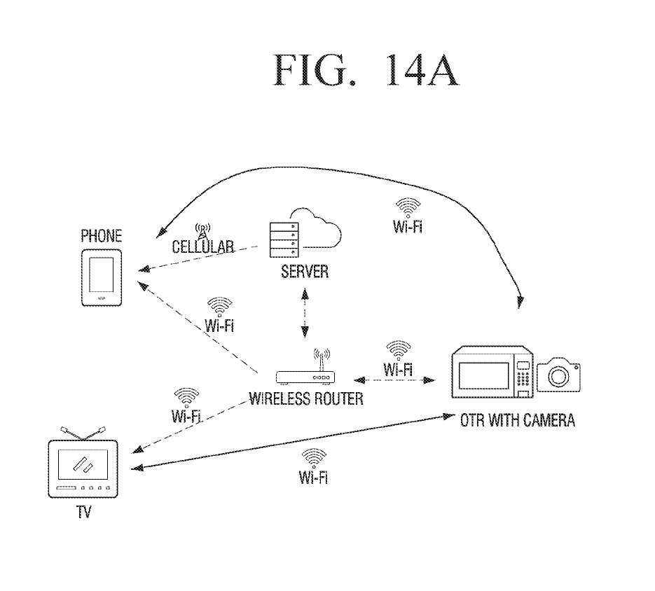

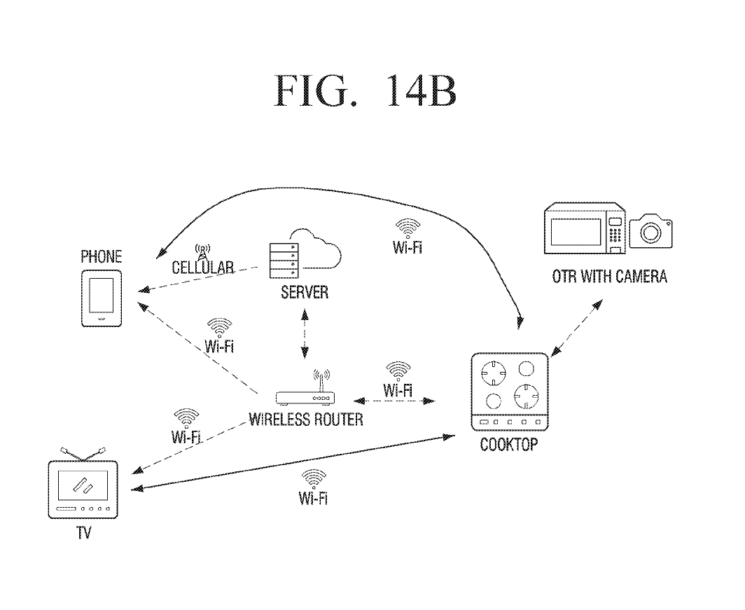

FIGS. 14A and 14B illustrate a way that a microwave performs communication according to embodiments of the present disclosure.

Referring to FIG. 14A, the microwave 100 according to an embodiment of the present disclosure can perform communication with the display device 200. Here, the display device 200 may be at least one of a user terminal device and an image providing device.

Referring to the dotted line of FIG. 14A, the microwave 100 may be connected to a wireless router using Wi-Fi communication and may perform communication with the display device 200 which is connected to the wireless router via communication.

The foregoing is merely exemplary, and as the solid line of FIG. 14A, the microwave 100 can perform direct communication with the display device 200 without passing through the wireless router.

Also, the microwave 100 can communicate with the server via a wireless router. Accordingly, the microwave 100 can be provided with additional services such as an upgrade service of the microwave 100 from the server.

However, this is only an embodiment, and the microwave 100 may be provided with a service provided by a server from a user terminal device that performs communication with the server. To this end, the user terminal device may receive a file for the additional service of the microwave 100 to the server and transmit it to the microwave 100 via communication.

Referring to FIG. 14B, the microwave 100 according to one embodiment of the present disclosure can perform communication with the cooktop device. In this case, the cooktop device can communicate with the display device 200 and the server in the same manner as the microwave 100 performs communication as in FIG. 14A.

The cooktop device can transmit a signal received from an external device such as the display device 200 and a server to the microwave 100 through a wired or wireless communication method and conversely transmit a signal received from the microwave 100 to an external device such as the display device 200 and the server. Here, the wireless communication method may be a variety of methods such as a Wi-Fi method and a Bluetooth method.

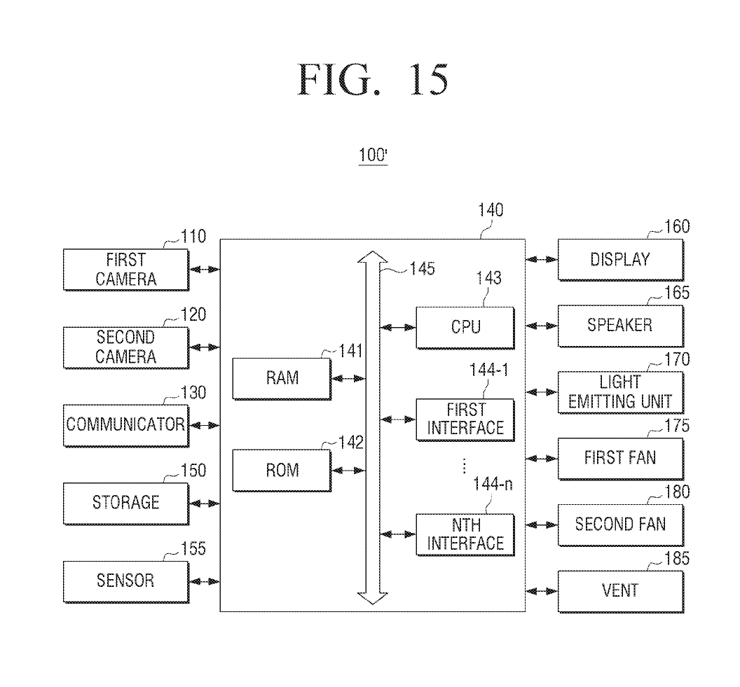

FIG. 15 illustrates a detailed block diagram of a microwave according to embodiments of the present disclosure.

Referring to FIG. 15, a microwave 100′ according to an embodiment of the present disclosure may include a first camera 110, a second camera 120, a communicator 130, a processor 140, a storage 150, a sensor 155, a display 160, a speaker 165, a light emitting unit 170, a first fan 175, a second fan 180, and a vent 185. Hereinafter, the description of the parts overlapping with the above description will be omitted.

The storage 150 may store commands or data related to components of the microwave 100′ and an operating system (OS) for controlling the overall operation of the components of the microwave 100′.

Accordingly, the processor 140 can control a plurality of hardware or software components of the microwave 100′ using various commands or data stored in the storage 150 and load commands or data received from at least one of other components to a nonvolatile memory, and store various data in the non-volatile memory. In particular, the storage 150 may store at least one of the image generated by the first camera and the image generated by the second camera according to an embodiment of the present invention.

The processor 140 controls overall operations of the microwave 100.

Specifically, the processor 140 includes a RAM 141, a ROM 142, a CPU 143, first to n^{th} interfaces 144-1 to 144-n, and a bus 145. Here, the RAM 141, the ROM 142, the CPU 143, the first to n^{th} interfaces 144-1 to 145-n, etc. may be connected to each other via the bus 145.

The first to n^{th} interfaces 144-1 to 145-n are connected to the various components described above. One of the interfaces may be a network interface connected to an external device via a network.

The CPU 143 accesses the storage 150 and performs booting using the O/S stored in the storage 150. The CPU 143 can perform various operations using various programs, contents and data stored in the storage 150.

The RAM 141 stores a command set for booting the system and the like. When the turn-on command is input and power is supplied, the CPU 143 copies the O/S stored in the storage 150 to the RAM 141 according to the command stored in the ROM 142, executes O/S to boot the system. When the booting is completed, the CPU 143 copies various programs stored in the storage 150 to the RAM 141, executes the program copied to the RAM 141, and performs various operations.

The sensor 155 may include at least one of a temperature sensing sensor and a smoke sensing sensor. Here, the temperature sensing sensor may include a sensor for sensing the temperature inside the microwave 100′ and a sensor for sensing the temperature of the cooking container on the cooktop. The smoke sensing sensor can sense smoke generated in the cooking container inside the microwave 100′ or the cooking container on the cooktop.

The display 160 may display various screens. For example, the display 160 may display a UI indicating that the microwave 100′ is communicating with the display device 200, and may display an image of the inside of the microwave 100. Further, the display 160 may display an image of the cooking container on the cooktop.

Also, the display 160 may be implemented as a touch screen to receive user input. Here, the user input may include a user input for transmitting at least one of the first and second images to the display device 200 while at least one of the first and second images is displayed on the display 160.

The speaker 165 may output sound. In one embodiment, when the smoke or the like is generated over a predetermined threshold value, the speaker 165 may output a warning sound indicating that smoke is being generated.

The light emitting unit 170 may be provided near the camera. For example, the light emitting unit 170 may be provided on at least one of the left and right sides of the first and second cameras, respectively. When the image is photographed through the camera, the light emitting unit 170 may be turned on when the brightness around the camera is equal to or less than a preset threshold value.

A first fan 175 can be provided near the first camera 110, and a second fan 180 may be provided near the second camera. Here, each fan can remove steam on the camera in the vicinity.

A vent 185 may suck at least one of steam or odor generated from the cooking object.

Though not illustrated in FIG. 15, the microwave 100 according to an exemplary embodiment may further include an electromagnetic wave generation unit for heating a cooking container inside the microwave 100′ and a duct for discharging smoke generated during cooking and sucked smoke to outside.

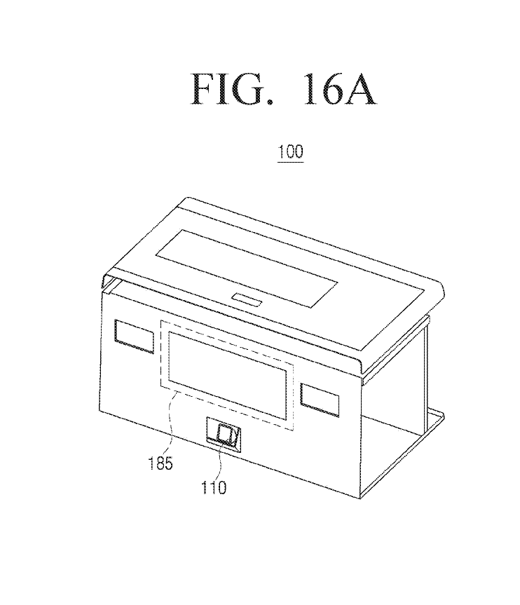

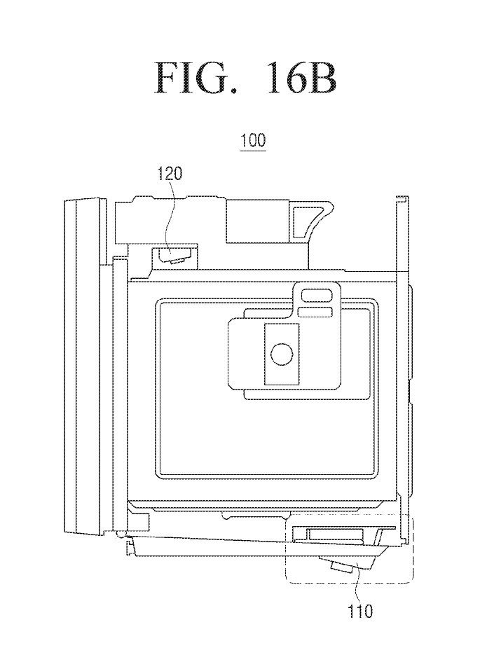

FIGS. 16A and 16B illustrate a structure of a microwave according to embodiments of the present disclosure.

FIG. 16A is a bottom view of the microwave 100. Referring to FIG. 16A, the vent 185 and the first camera 110 may be provided on a lower surface of the microwave 100. Here, the vent is a device for sucking steam, smoke or odor generated in a cooking object, and the microwave 100 can suck up steam, smoke, or an odor through the vent 185.

As illustrated in FIG. 16A, the vent 185 is provided at the center of the lower surface of the microwave 100, and the first camera 110 may be disposed in the rear area of the vent 185 in the lower surface of the microwave 100. However, this is only an example, and the first camera 110 may be provided at various positions where the cooktop of the microwave 100 can be photographed.

For example, the first camera 110 may be provided at the center of the lower surface of the microwave 100. In this case, the vent 185 may be provided in at least one of the side areas of the first camera 110, that is, the front, back, left, and right areas of the first camera 110.

FIG. 16B is a view to illustrate a left side or right side of the microwave 100.

Referring to FIG. 16B, the first camera 110 for photographing the inside of the microwave 100 may be provided in one of the upper surfaces of the microwave 100. In FIG. 16B, an area where the first camera 110 is merely exemplary and the first camera may be provided at various positions that can photograph the inside of the microwave 100, such as the center of the upper surfaces of the microwave 100, or the like.

The second camera 120 for photographing the cooktop located below the microwave 100 may be provided in one of the lower surfaces of the microwave 100 as shown in FIG. 16B.

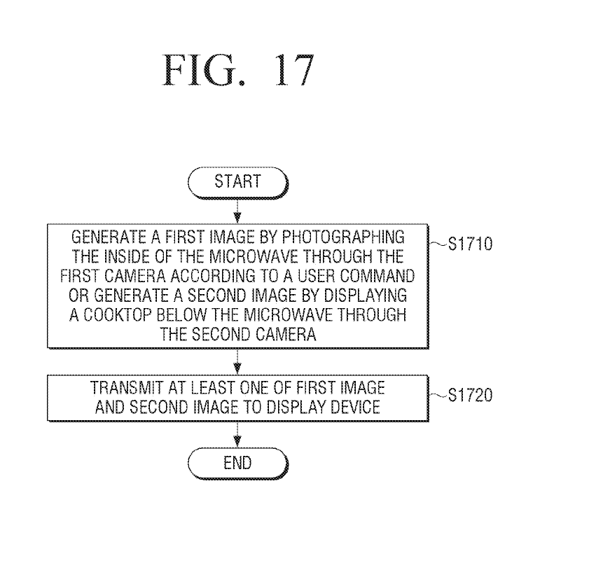

FIG. 17 illustrates a flowchart to describe operations of a microwave according to embodiments of the present disclosure.

The microwave may generate a first image by photographing the inside of the microwave through the first camera according to a user command or generate a second image by displaying a cooktop located below the microwave through the second camera (S1710). Here, the user command may be input to a display device that performs communication with the microwave. Specifically, when a command to display at least one image of the first and second images is input to the display device, the microwave can receive a signal requesting at least one of the first and second images from the display device and generate at least one of the first and second images based on the received signal. However, the above is merely exemplary and the microwave may have a separate button, and may generate at least one of the first and second images according to a user command input to the button.

Thereafter, the microwave may transmit at least one of the first and second images to the display device (S1720). Accordingly, the display device can display at least one of the first and second images, and the user can continuously check the cooking object even in an area outside the kitchen.

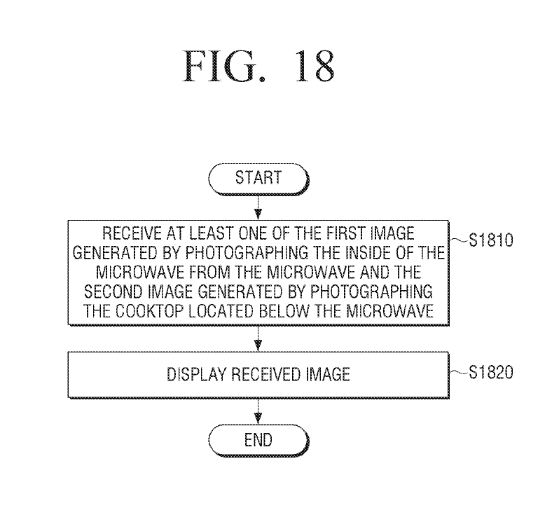

FIG. 18 illustrate a flowchart to describe the operation of the display device according to embodiments of the present disclosure.

The display device may receive at least one of the first image generated by photographing the inside of the microwave from the microwave and the second image generated by photographing the cooktop located below the microwave (S1810).

Specifically, the display device may transmit a signal requesting the first image to the microwave based on user input, and may receive the first image from the microwave. Likewise, the display device may transmit a signal requesting a second image to the microwave based on user input and receive a second image from the microwave. In addition, the display device may transmit the first and second images to the microwave based on the user input, and receive the first and second images from the microwave. In addition, the display device may display the received image (S1810).

Thus, by displaying the image of the inside of the microwave 100 photographed by the display device 200 or the image of the cooktop, the user can continuously check the cooking object even in an area outside the kitchen.

Meanwhile, the methods according to various embodiments of the present invention described above can be implemented in the form of software or application that can be installed in an existing microwave. In addition, the methods according to various embodiments of the present invention described above can be implemented by a software upgrade, or a hardware upgrade, for an existing microwave. In addition, the various embodiments of the present invention described above can be performed through an embedded server provided in the microwave, or a server outside the microwave. Meanwhile, a non-transitory computer readable medium may be provided in which a program for sequentially performing the method of controlling a microwave according to the present invention is stored.

The non-transitory computer-recordable medium is not a medium configured to temporarily store data such as a register, a cache, or a memory but an apparatus-readable medium configured to semi-permanently store data. Specifically, the above-described various applications or programs may be stored in the non-transitory apparatus-readable medium such as a compact disc (CD), a digital versatile disc (DVD), a hard disc, a disc, a universal serial bus (USB), a memory card, or a read only memory (ROM), and provided therein.

The foregoing exemplary embodiments and advantages are merely exemplary and are not to be construed as limiting the inventive concept. The exemplary embodiments may be readily applied to other types of device or apparatus. Also, the description of the exemplary embodiments is intended to be illustrative, and not to limit the scope of the inventive concept, and many alternatives, modifications, and variations will be apparent to those skilled in the art.

Although the present disclosure has been described with various embodiments, various changes and modifications may be suggested to one skilled in the art. It is intended that the present disclosure encompass such changes and modifications as fall within the scope of the appended claims.

What is claimed is:

1. A cooking system, comprising:
a microwave configured to:
in response to a received user command, generate a first image by photographing a cooktop located below the microwave through a first camera or generate a second image by photographing an inside of the microwave through a second camera, and
transmit at least one of the first image and the second image to a display device; and
a display device configured to:
receive at least one of the first image and the second image from the microwave, and
display the received at least one image.

2. The cooking system of claim 1, wherein the display device, in response to receiving of a user input, is further configured to transmit a control command for controlling at least one of the microwave and the cooktop to the microwave, and
wherein the microwave is further configured to:
receive the control command from the display device, and
controls operations of at least one of the microwave and the cooktop according to the received control command.

3. The cooking system of claim 1, wherein the first camera photographs a first cooking container positioned on the cooktop from a first photographing direction, and the second camera photographs a second cooking container positioned inside the microwave in a second photographing direction,
wherein the microwave is further configured to modify the first image that photographs the first cooking container in the first photographing direction and the second image that photographs the second cooking container in the second photographing direction to images corresponding to a third photographing direction, wherein the third photographing direction corresponds to a vertical direction of the first and second cooking container.

4. The cooking system of claim 1, a content is being displayed on the display device, the display device is further configured to:
in response to a received user input to display at least one image out of the first image and the second image is received, receive the at least one image out of the first image and the second image from the microwave; and
overlap the received at least one image with the content; and
display the received at least one image with the content.

5. The cooking system of claim 4, wherein the display device is further configured to, in response to a received user input to change at least one of a size and a position of the displayed at least one image, change at least one of a size and a position of the displayed at least one image according to the received user input.

6. The cooking system of claim 1, wherein:
the microwave is further configured to:
identify a degree of bubble generation in a cooking container located inside the microwave or a cooking container positioned on the cooktop, based on the first image and the second image, and
transmits a notification message indicating the identified degree of bubbles to the display device; and
the display device is further configured to display the notification message received from the microwave.

7. The cooking system of claim 1, wherein:
the microwave is further configured to
identify a degree of smoke generation in a cooking container positioned inside the microwave or in a cooking container positioned on the cooktop, based on the first image and the second image,
transmit a notification message indicating the identified degree of smoke, and
when the identified degree of smoke is greater than or equal to a predetermined threshold value, stop an electronic unit or drive a hood of the microwave; and
the display device is further configured to display the notification message received from the microwave.

8. The cooking system of claim 1, wherein the microwave is further configured to
identify a degree of blur from at least one image out of the first image and the second image,
when the degree of blur is greater than or equal to a preset threshold value, identify a camera that photographs an image out of the first camera and the second camera, and
operates a fan that is provided in a vicinity of the identified camera.

9. A microwave, comprising:
an electronic unit;
a first camera;
a communicator; and
a processor configured to, in response to a received user command, control the communicator to generate a first image by photographing a cooktop positioned below the microwave through the first camera and transmit the first image to a display device.

10. The microwave of claim 9, further comprising:
a second camera,
wherein the processor is further configured to controls the communicator to generate a second image by photographing an inside of the microwave through the second camera, and transmit the second image to display device.

11. The microwave of claim 9, wherein the processor is further configured to:
receive a control command to control at least one of the microwave and the cooktop from the display device; and
controls operations of at least one of the microwave and the cooktop according to the received control command.

12. The microwave of claim 10, wherein the first camera is disposed at a specific position of the microwave to photograph a cooking container positioned on the cooktop in a diagonal direction, and the second camera is disposed at a specific position of the microwave to photograph a cooking container positioned inside the microwave in a diagonal direction,
wherein the processor is further configured to:
modify an image that photographs the cooking container in the diagonal direction by the first camera and the second camera; and
transmits the modified image to the display device,
wherein the modified image corresponds to an image photographed the cooking container in a vertical direction.

13. The microwave of claim 10, wherein the processor is further configured to:
identify a degree of bubble generation in a cooking container located inside the microwave or a cooking container positioned on the cooktop, based on the first image and the second image; and
transmits a notification message indicating the identified degree of bubbles to the display device.

14. The microwave of claim 10, wherein the processor is further configured to:
identify a degree of smoke generation in a cooking container positioned inside the microwave or in a cooking container positioned on the cooktop, based on the first image and the second image;
transmits a notification message indicating the identified degree of smoke; and
when the identified degree of smoke is greater than or equal to a predetermined threshold value, stop the electronic unit or drive a hood of the microwave.

15. The microwave of claim 10, wherein the processor is further configured to:
identifies a degree of blur from at least one image out of the first image and the second image;
when the degree of blur is greater than or equal to a preset threshold value, identify a camera that photographs an image out of the first camera and the second camera; and
operates a fan that is provided in a vicinity of the identified camera.

16. A display device comprising:
a display;
a communicator; and
a processor configured to:
receive, through the communicator, at least one image including a first image that photographs a cooktop located below a microwave and a second image that photographs inside the microwave, and
displays the received at least one image on the display.

17. The display device of claim 16, wherein the processor is further configured to transmit a control command to control at least one of the microwave and the cooktop to the microwave, in response to receiving of a user input.

18. The display device of claim 16, wherein while content is displayed the processor is further configured to:
in response to a received user input o display at least one image out of the first image and the second image, receive the at least one image out of the first image and the second image from the microwave;
overlap the received at least one image with the content; and
display the received at least one image with the content.

19. The display device of claim 16, wherein the processor is further configured to, in response to a received user input to change at least one of a size and a position of the displayed at least one image, changes at least one of a size and a position of the displayed at least one image according to the received user input.

20. The display device of claim 16, wherein:
the communicator is configured to communicate wirelessly with the cooktop; and
the processor is further configured to transmit a control command to the cooktop, wherein the control command includes at least one of:
instructions to power on or off of the cooktop,
instructions to set a cooking time of the cooktop, or
instructions to set a temperature of the cooktop.
